(19) United States
(12) Patent Application Publication
(10) Pub. No.: US 2012/0086602 A1
(43) Pub. Date: Apr. 12, 2012

(54) HYBRID BEAM FORMING APPARATUS IN WIDEBAND WIRELESS COMMUNICATION SYSTEM

(75) Inventors: Kyung Hwan Park, Daejeon (KR); Sung Weon Kang, Daejeon (KR); Kyungsoo Kim, Daejeon (KR); Jung Bum Kim, Daejeon (KR); In Gi Lim, Daejeon (KR); Chang Hee Hyoung, Daejeon (KR); Byoung Gun Choi, Daegu (KR); Jung Hwan Hwang, Daejeon (KR); Tae Young Kang, Seoul (KR); Hyung-Il Park, Daejeon (KR); Sung Eun Kim, Seoul (KR); Tae Wook Kang, Daejeon (KR)

(73) Assignee: Electronics and Telecommunications Research Institute, Daejeon (KR)

(21) Appl. No.: 13/269,288

(22) Filed: Oct. 7, 2011

(30) Foreign Application Priority Data
Oct. 8, 2010 (KR) 10-2010-0098264
Sep. 28, 2011 (KR) 10-2011-0098484

(51) Int. Cl. H01Q 3/00; G01S 3/02

(52) U.S. Cl. 342/372; 342/442

(57) ABSTRACT

A beam forming apparatus includes: a receiver including a plurality of digital phase shifters configured to estimate an angle of arrival (AOA) of a received signal; and a transmitter including a plurality of analog phase shifters configured to perform phase shift based on the estimated AOA or a designated angle of orientation.

### CROSS-REFERENCES TO RELATED APPLICATIONS

The present application claims priority under 35 U.S.C 119(a) to Korean Application No. 10-2010-0098264, filed on Oct. 8, 2010 and Korean Application No. 10-2011-0098484, filed on Sep. 28, 2011 in the Korean intellectual property Office, which is incorporated herein by reference in its entirety set forth in full.

### BACKGROUND

Exemplary embodiments of the present invention relate to a hybrid beam forming apparatus in a wideband wireless communication system, and more specifically to a hybrid beam forming apparatus in a wideband wireless communication system, which is capable of quickly detecting a beam direction to form beams without distortion and selecting and controlling a bandwidth such that signal distortion is minimized with response to a wideband signal.

In a conventional wireless communication system, a variety of directional antenna technologies or beam forming technologies for increasing an antenna gain in a specific direction has been developed in order to secure as many communication channels as possible within limited radio resources or increase transmission/reception power efficiency.

Beaming forming refers to an antenna implementation method in which energy emitted from an antenna is concentrated along a specific direction, and has been developed to receive a signal from a desired direction or transmit a signal in a desired direction.

The beam forming technology may be used to control phase information for each antenna to adjust the intensity of a signal according to a position angle between a base station and a mobile station. Then, surrounding interference may be removed to increase the performance. Instead of an existing antenna forming emission beams in all directions, directional beams may be emitted only to a corresponding subscriber to minimize the influence of signal interference on all subscribers taking an active part in the corresponding sector. Therefore, it is possible to increase a communication quality and a system channel capacity.

In connection with the beam forming technology, Korean Patent No. 0777563 has disclosed a transmission/reception device of a base station, which shifts the center frequency of a signal received through each antenna element to an intermediate frequency region and weights the amplitude and phase of the signal in the shifted intermediate frequency region, such that a plurality of transmitters/receivers behind the antenna element may have the same transmission characteristic. Therefore, direction detection and beam forming may be easily performed.

Furthermore, Korean Patent No. 0540170 has disclosed a beam forming apparatus and method using estimation of the incident angle of a main path signal. In the beam forming apparatus and method, an incident angle at which the spatial spectrum of a multi-path signal is maximized is decided as the incident angle of a main path signal, and a weight calculated on the basis of the incident angle is applied to the multi-path signal to form a beam pattern.

In the case of the directional beam forming, however, the direction of received radio waves should coincide with a direction in which a radiation gain of beams is maximized, in order to increase transmission/reception efficiency. The beam forming is implemented by using an array antenna, and the phase of each array signal may be shifted to search for the direction of arrival of the signal or steer beams in a desired direction.

In general, the phase shift of the array signal may be performed by a digital phase shifter or analog phase shifter.

In the digital phase shifter, a digital unit performs phase shift. In the analog phase shifter, however, a radio frequency (RF) unit performs phase shift. Therefore, the system architectures of both phase shifters are different from each other.

A system using the digital phase shifter should maintain an independent array signal up to a baseband. Therefore, since the system uses a plurality of transceivers corresponding to the array number, the size of the system is increased, and the system has large power consumption. However, the system may form a plurality of independent beams.

On the other hand, a system using the analog phase shifter uses one transceiver including a plurality of RF circuits corresponding to the array number. Therefore, the system is relatively simple and has small power consumption. However, the system may form only one beam.

Furthermore, the beam forming method using the phase shift of an array signal may be effectively used only for a narrow band signal. That is, a phase set by the phase shifter is effective only at a specific frequency, and may exhibit an error at a different frequency from the corresponding frequency.

Therefore, the phase of a wideband signal may be shifted to different phases at a lower cut-off frequency, a specific frequency, and an upper cut-off frequency, respectively. Accordingly, when an array signal is synthesized, the signal may be distorted by the dispersed phases.

Therefore, there is demand for an apparatus and method which is capable of quickly detecting a beam direction and forming beams without distortion, in a wideband wireless communication system.

The background is described in Korean Patent Publication No. 10-2003-0058265 (Jul. 7, 2003).

### SUMMARY

An embodiment of the present invention relates to a hybrid beam forming apparatus in a wideband wireless communication system, which is capable of quickly detecting a beam direction to form beams without distortion and selecting and controlling a bandwidth such that signal distortion is minimized with response to a wideband signal.

Another embodiment of the present invention relates to a hybrid beam forming apparatus in a wideband wireless communication system, which is capable of effectively performing bean detection and beam forming by using only advantages of a digital phase shifter and an analog phase shifter.

In one embodiment, a beam forming apparatus includes: a receiver including one or more digital phase shifters configured to estimate an angle of arrival (AOA) of a received signal; and a transmitter including one or more analog phase shifters configured to perform phase shift based on the estimated AOA or a designated angle of orientation.

The receiver may include: a synthesizer configured to synthesize signals of antennas, of which the phases are shifted to change the AOAs of the signals received by the respective antennas by a designated angle and which are outputted from the digital phase shifters; and an AOA detector configured to output a phase control value to the digital phase shifters and decide the AOA of the received signals by using an AOA having a radiation gain within a predetermined range, based on a subtraction value between radiation gains of two signals among output signals of the synthesizer.

The transmitter may include a steering angle and bandwidth decision unit configured to decide a steering angle by using the AOA information provided from the AOA detector and combine the decided steering angle and a signal bandwidth to decide a bandwidth which satisfies a predetermined phase error.

A reception bandwidth control value corresponding to the bandwidth decided by the steering angle and bandwidth decision unit may be provided to filters and amplifiers of the receiver to receive a signal corresponding to the bandwidth.

The steering angle and bandwidth decision unit may decide the bandwidth based on a predetermined beam steering angle and array number, such that a phase error between array signals after phase shift becomes equal to or less than a predetermined value.

The phase error may be expressed as (n−1)δkd, where n represents an array element number, k represents a wave number with respect to a frequency, and d represents a path difference.

### BRIEF DESCRIPTION OF THE DRAWINGS

The above and other aspects, features and other advantages will be more clearly understood from the following detailed description taken in conjunction with the accompanying drawings, in which:

FIG. 1 is a block configuration diagram of a hybrid beam forming apparatus in accordance with an embodiment of the present invention;

FIG. 2 is a block configuration diagram of a receiver 100 of the hybrid beam forming apparatus in accordance with the embodiment of the present invention; and

FIG. 3 is a block configuration diagram of a transmitter 200 of the hybrid beam forming apparatus in accordance with the embodiment of the present invention.

### DESCRIPTION OF SPECIFIC EMBODIMENTS

Hereinafter, embodiments of the present invention will be described with reference to accompanying drawings. The present invention may, however, be embodied in different forms and should not be constructed as limited to the embodiments set forth herein, but it should be understood that the idea of the present invention should be construed to extend to any alterations, equivalents and substitutes besides the accompanying drawings.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Although terms like a first and a second are used to describe various elements, the elements are not limited to the terms. The terms are used only to discriminate one element from another element.

The terminology used herein is for the purpose of describing particular embodiments only and is not intended to be limiting of the invention. As used herein, the singular forms are intended to include the plural forms as well, unless the context clearly indicates otherwise. It will be further understood that the terms “comprise”, “comprising”, “have” and/or “having”, when used herein, specify the presence of stated features, integers, steps, operations, elements, and/or components, but do not preclude the presence or addition of one or more other features, integers, steps, operations, elements, components, and/or groups thereof.

Furthermore, terms such as “ . . . part”, “ . . . unit”, and “ . . . module” mean a unit which processes one or more functions or operations, and may be implemented by hardware, software, or a combination of hardware and software.

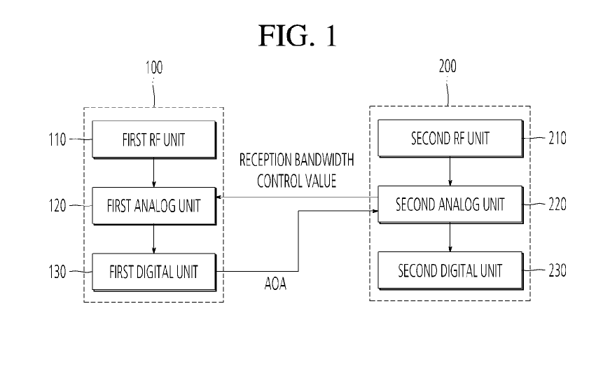

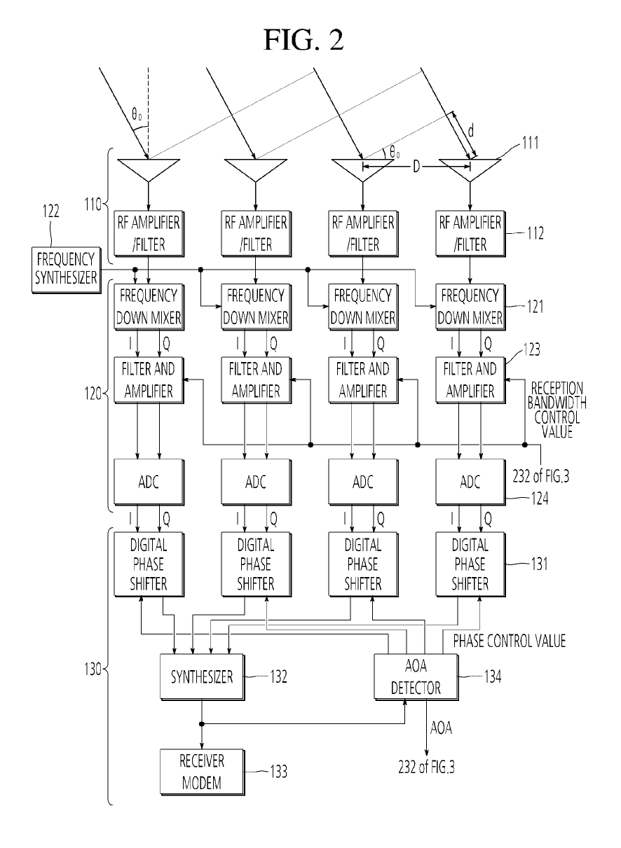

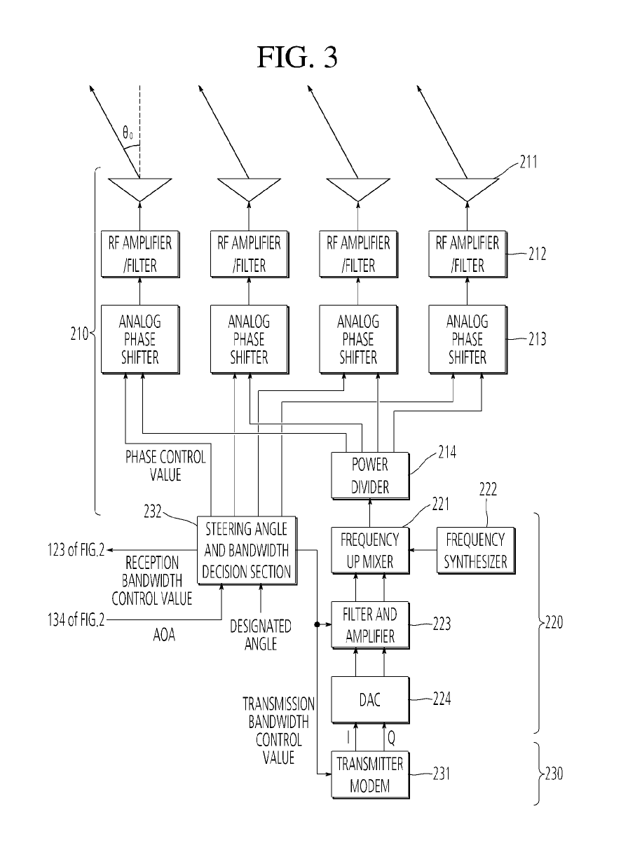

FIG. 1 is a block configuration diagram of a hybrid beam forming apparatus in accordance with an embodiment of the present invention. FIG. 2 is a block configuration diagram of a receiver 100 of the hybrid beam forming apparatus in accordance with the embodiment of the present invention. FIG. 3 is a block configuration diagram of a transmitter 200 of the hybrid beam forming apparatus in accordance with the embodiment of the present invention.

As will be described below, the hybrid beam forming apparatus in accordance with the embodiment of the present invention has the following architectural characteristic. The hybrid beam forming apparatus shifts the phase of a signal received from an array antenna such that the angle of arrival (AOA) of the received signal is changed by a predetermined angle, detects and estimates the AOA to form beams in the direction of the AOA, and selects and controls a bandwidth to minimize signal distortion with respect to the a wideband signal.

Furthermore, in the hybrid beam forming apparatus, the receiver 100 uses digital phase shifters 131 to quickly and accurately estimate an AOA and, the transmitter 200 uses analog phase shifters 213 to increase transmission efficiency. The hybrid beam forming apparatus is configured to control a bandwidth with respect to a steering angle, in order to reduce transmission distortion of a wideband signal.

The receiver 100 converts an RF signal received through the array antenna into a baseband signal, and a first digital unit 130 simultaneously uses various combinations of digital phase shifters 131 to quickly detect and estimate the AOA of the signal.

The transmitter 200 converts a baseband signal into an RF signal and uses the analog phase shifters 213 included in a second RF unit 210 to shift the phase of the signal, thereby acquiring a maximum radiation gain at the estimated AOA or a desired angle of orientation.

Furthermore, the transmitter 200 may discriminate the estimated AOA or the desired angle of orientation and control a transmission signal bandwidth such that a phase error between an upper cut-off frequency and a lower cut-off frequency of the signal becomes equal to or less than a predetermined value (for example, 30%).

Hereinafter, referring to FIGS. 1 to 3, the operation of the hybrid beam forming apparatus in accordance with the embodiment of the present invention will be described briefly. Since the functions and operations of components illustrated in the drawings (for example, an RF amplifier, a frequency down mixer and so on) are obvious to those skilled in the art, the detailed descriptions thereof will be omitted.

Referring to FIG. 1, the hybrid beam forming apparatus may include the receiver 100 and the transmitter 200. The receiver 100 includes a first RF unit 110, a first analog unit 120, and a first digital unit 130, and the transmitter 200 includes a second RF unit 210, a second analog unit 220, and a second digital unit 230. FIGS. 2 and 3 specifically illustrate detailed components included in the respective components of the receiver 100 and the transmitter 200. For convenience of description, duplicated components are represented by one reference numeral in FIGS. 2 and 3.

In the receiver 100, signals received by antennas of a receiving array antenna 111 are inputted to RF amplifiers/filters 112, and then inputted to the digital unit 130 through frequency down mixers 121, filters and amplifiers 123, and analog-digital converters (ADC) 124.

Digital phase shifters 131 of the digital unit 130 are configured to sequentially receive phase control values for AOA search from an AOA detector 134, shift the phases of the signals inputted from the ADCs 124, and then outputs the signals to a synthesizer 132. The synthesizer 132 is configured to synthesize the array signal, and the AOA detector 134 is configured to estimate an AOA at which a maximum signal is obtained, using the synthesized signal.

That is, the synthesizer 132 synthesizes the signals of the respective antennas, of which the phases are shifted to change the AOA of the signals received by the respective antennas by a designated angle and which are outputted from the digital phase shifters 131, and the AOA detector 134 outputs the phase control values to the digital phase shifters 131 and decides the AOA of the received signals by using an AOA having a radiation gain within a predetermined range, based on a subtraction value between radiation gains of two signals among output signals of the synthesizer 132.

The AOA information estimated by the AOA detector 134 is provided to a steering angle and bandwidth decision section 232 of the transmitter 200 and used as information for deciding the steering angle of the transmitter 200. The steering angle and bandwidth decision section 232 combines the decided steering angle and a given signal bandwidth and derives a new bandwidth in which a phase error does not exceed a predetermined reference.

The steering angle and bandwidth decision section 232 provides the derived bandwidth information to a transmitter modem 231, a filter and amplifier 223, and the filters and amplifiers 123 of the receiver 100 such that a signal suitable for the corresponding bandwidth is transmitted and received. The steering angle and bandwidth decision section 232 may decide a bandwidth based on a predetermined beam steering angle and the array number, such that a phase error of the array signal after phase shift becomes equal to or less than a predetermined value.

Furthermore, the steering angle and bandwidth decision section 232 derives a phase control value for the decided steering angle, and provides the derived phase control value to the analog phase shifters 213 included in the second RF unit 210 to perform phase control. Accordingly, the beam formed transmission for the wideband signal may be achieved.

An equation proving that a phase error occurs in the array signal due to the steering angle and bandwidth may be expressed as follows. Since reversibility between reception and transmission of the array signal is established, only the reception is proved herein.

First, when a single frequency similar to narrow band communication is described, the array signal in the receiving antennas 111 may be expressed as Equation 1 below.

r₁(t)=A cos [w₀t+φ₀]

r₂(t)=A cos [w₀t+φ₀+k₀d]

r₁(t)=A cos [w₀t+φ₀+2k₀d]

r₁(t)=A cos [w₀t+φ₀+3k₀d] [Equation 1]

Here, f₀ represents an RF frequency (that is, ω₀=2πf₀), φ₀ represents an initial phase, k₀ represents a wave number (that is, 2π/λ₀ or 2πf₀/c), D represents an array antenna distance, θ₀ represents an AOA (that is, an incident angle based on a vertical line with respect to an array surface), and d represents a path difference between arrays (that is, D sin θ₀).

When the signal passes through the frequency down mixers 121 and the filters and amplifiers 123, the signal is converted into I/Q signals as expressed as Equation 2 below.

$${\tilde{r}}_{n}^{I} ( t ) = A \frac{cos [ {φ}_{0} + ( n - 1 ) {k}_{0} d ]}{2} \\ {\tilde{r}}_{n}^{Q} ( t ) = - A \frac{sin [ {φ}_{0} + ( n - 1 ) {k}_{0} d ]}{2} \qquad [ Equation 2 ]$$

Here, n represents an array element number.

When the digital phase shifters 131 shift the phase of the array signal according to a vector modulation method, the signal may be expressed as Equation 3 below.

$${\tilde{r}}_{n}^{I} ( t ) cos [ ( n - 1 ) {w}_{0} {τ}_{0} ] - {\tilde{r}}_{n}^{Q} ( t ) sin [ ( n - 1 ) {w}_{0} {τ}_{0} ] = A \frac{cos [ {φ}_{0} + ( n - 1 ) {k}_{0} d ]}{2} cos [ ( n - 1 ) {w}_{0} {τ}_{0} ] + A \frac{sin [ {φ}_{0} + ( n - 1 ) {k}_{0} d ]}{2} sin [ ( n - 1 ) {w}_{0} {τ}_{0} ] = A \frac{cos [ {φ}_{0} + ( n - 1 ) {k}_{0} d - ( n - 1 ) {w}_{0} {τ}_{0} ]}{2} = A \frac{cos [ {φ}_{0} ]}{2} \qquad [ Equation 3 ]$$

Finally, when the synthesizer 132 synthesizes the array signal, the synthesized signal may be expressed as Equation 4 below.

$$Sum of N BB vector modulation outputs = \frac{N}{2} A cos [ {φ}_{0} ] \qquad [ Equation 4 ]$$

Accordingly, beam forming for the AOA may be performed to acquire a maximum array synthesis value.

Next, when a multiple frequency similar to wideband communication is described, the array signal in the receiving antennas 111 may be expressed as Equation 5 below.

rₙ(t)=A cos [w₀t+φ₀+(n−1)k₀d]+B cos [w_{ε}t+φ₀+(n−1)k_{ε}d] [Equation 5]

Here, n represents an array element number, f₀ represents an RF center frequency (that is, ω₀=2πf₀), f_{ε} represents an RF edge frequency (that is, f_{ε}=f₀+εf and ω_{ε}=2πf_{ε}), k₀ represents a wave number with respect to the center frequency (that is, 2πf₀/c), and k_{ε} represents a wave number with respect to the edge frequency (that is, 2πf_{ε}/c).

When the signal passes through the frequency down mixers 121 and the filters and amplifiers 123, the signal is converted into I/Q signals as expressed as Equation 6 below.

$${\tilde{r}}_{n}^{I} ( t ) = A \frac{cos [ {φ}_{0} + ( n - 1 ) {k}_{0} d ]}{2} + B \frac{cos [ {w}_{b} t + {φ}_{0} + ( n - 1 ) {k}_{ε} d ]}{2} \\ {\tilde{r}}_{n}^{Q} ( t ) = - A \frac{sin [ {φ}_{0} + ( n - 1 ) {k}_{0} d ]}{2} - B \frac{sin [ {w}_{b} t + {φ}_{0} + ( n - 1 ) {k}_{ε} d ]}{2} \qquad [ Equation 6 ]$$

Here, a relation of ω_{b}=2πδf and δf=f_{ε}−f₀ is established.

When the digital phase shifters 131 of the receiver 100 shift the phase of the array signal according to the vector modulation method and the synthesizer 132 synthesizes the array signal, the synthesized signal may be expressed as Equation 7.

$$\frac{N}{2} A cos [ {φ}_{0} ] + {\sum }_{n = 1}^{N} B \frac{cos [ {w}_{b} t + {φ}_{0} + ( n - 1 ) δ kd ]}{2} \qquad [ Equation 7 ]$$

When the same phase shift is performed on the two frequencies, perfect beam forming may be achieved, and the synthesized signal may be expressed as Equation 8 below.

$$( \frac{NA}{2} ) cos [ {φ}_{0} ] + ( \frac{NB}{2} ) cos [ {w}_{b} t + {φ}_{0} ] \qquad [ Equation 8 ]$$

However, since desired phase shift may be performed only for one frequency due to the characteristic of the phase shifters, a phase error as expressed as Equation 9 below occurs.

(n−1)δkd, [Equation 9]

where a relation of

$$δ k = \frac{2 π}{c} δ f and d = D sin {θ}_{0}$$

is satisfied

In conclusion, when the phase shifters are controlled with respect to the center frequency of the signal band, an equation in which the phase difference is proportional to a difference between two frequencies (that is, bandwidth/2) and the AOA may be derived.

Therefore, the transmitter 200 in accordance with the embodiment of the present invention may be driven in the following manner. When the AOA is smaller than a predetermined value, a phase error is small even though the bandwidth is large. Therefore, the transmitter 200 transmits a wideband signal as it is. On the other hand, when the AOA is larger than the predetermined value, the phase error is increased by the bandwidth. Therefore, the transmitter 200 may reduce the bandwidth. At this time, the predetermined value may be decided as a proper value by an experimental and statistical method.

In general, the AOA estimation is to detect an AOA at which the largest signal enters. An angle at which the largest signal is caught at an arbitrary frequency within the bandwidth regardless of the bandwidth may be searched for to estimate the AOA. Therefore, as described above, the receiver 100 of the hybrid beam forming apparatus in accordance with the embodiment of the present invention may quickly detect and estimate the AOA by using the digital phase shifters capable of performing parallel processing. The estimated AOA is provided to the transmitter 200 and used as a phase control value for transmission beam forming.

Meanwhile, when the phase of a wideband array signal is shifted on the basis of a specific frequency, the phase shift may be accurately performed only at a specific frequency, and the phase may be shifted to an undesired value at an arbitrary frequency (for example, specific frequency±(bandwidth/2)). In this case, desired beam forming may not be achieved, when the array signals are synthesized. In order to achieve proper beam forming, all array signals should be in phase. At frequencies other than the specific frequency, the array signals have different phases, and an effect of the synthesis may be reduced or interference may occur between the array signals.

A phase error at an arbitrary frequency within the baseband is decided by a distance from the specific frequency and a beam steering angle. Since the distance from the specific frequency is proportional to the signal bandwidth, the distance from the specific frequency should be reduced when a phase error equal to or more than a predetermined reference at a give beam steering angle is expected.

However, in the hybrid beam forming apparatus in accordance with the embodiment of the present invention, the transmitter 200 is provided with a function of controlling the signal bandwidth. Accordingly, the above-described phase error may be controlled to minimize the distortion of a wideband array signal.

Furthermore, since the second RF unit 210 of the transmitter 200 in the hybrid beam forming apparatus includes the analog phase shifters 213, one transceiver may be used before the RF circuit. Therefore, the system may be simply configured, and has small power consumption.

In accordance with the embodiment of the present invention, the beam forming apparatus in a wideband wireless communication system may quickly detect the beam direction to form beams without distortion, and select and control a bandwidth such that signal distortion for a wideband signal is minimized.

Furthermore, the beam forming apparatus may perform the beam detection and beam forming effectively by using only advantages of the digital phase shifters and the analog phase shifters.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A beam forming apparatus comprising:
a receiver comprising one or more digital phase shifters configured to estimate an angle of arrival (AOA) of a received signal; and
a transmitter comprising one or more analog phase shifters configured to perform phase shift based on the estimated AOA or a designated angle of orientation.

2. The beam forming apparatus of claim 1, wherein the receiver comprises:
a synthesizer configured to synthesize signals of antennas, of which the phases are shifted to change the AOAs of the signals received by the respective antennas by a designated angle and which are outputted from the digital phase shifters; and
an AOA detector configured to output a phase control value to the digital phase shifters and to decide the AOA of the received signals by using an AOA having a radiation gain within a predetermined range, based on a subtraction value between radiation gains of two signals among output signals of the synthesizer.

3. The beam forming apparatus of claim 2, wherein the transmitter comprises a steering angle and bandwidth decision unit configured to decide a steering angle by using the AOA information provided from the AOA detector and to combine the decided steering angle and a signal bandwidth to decide a bandwidth which satisfies a predetermined phase error.

4. The beam forming apparatus of claim 3, wherein a reception bandwidth control value corresponding to the bandwidth decided by the steering angle and bandwidth decision unit is provided to filters and amplifiers of the receiver to receive a signal corresponding to the bandwidth.

5. The beam forming apparatus of claim 3, wherein the steering angle and bandwidth decision unit decides the bandwidth based on a predetermined beam steering angle and array number, such that a phase error between array signals after phase shift becomes equal to or less than a predetermined value.

6. The beam forming apparatus of claim 3, wherein the phase error is expressed as (n−1)δkd, where n represents an array element number, k represents a wave number with respect to a frequency, and d represents a path difference between arrays.
